(19) United States
(12) Patent Application Publication
(10) Pub. No.: US 2017/0368564 A1
(43) Pub. Date: Dec. 28, 2017

(54) FOAM FORMULA AND DISPENSING APPARATUS

(71) Applicants: William Christopher Baker, Cincinnati, OH (US); Cyndie Elaine Fuller, Greenwood, IN (US); Drew Tyler Hampton, Hamilton, OH (US)

(72) Inventors: William Christopher Baker, Cincinnati, OH (US); Cyndie Elaine Fuller, Greenwood, IN (US); Drew Tyler Hampton, Hamilton, OH (US)

(21) Appl. No.: 15/636,207

(22) Filed: Jun. 28, 2017

Related U.S. Application Data
(60) Provisional application No. 62/355,402, filed on Jun. 28, 2016.

(51) Int. Cl. B05B 11/00; A23P 30/40; A23L 2/52; B01F 17/00

(52) U.S. Cl. CPC B05B 11/3087; B05B 11/3074; B01F 17/0085; B01F 17/0078; A23P 30/40; B01F 17/0028; B01F 17/005; A23L 2/52; A23V 2002/00

(57) ABSTRACT

A liquid foam composition and a foam dispenser. The liquid foam composition includes a combination of water, a surfactant, and a emulsifier. The foam dispenser includes a container containing the liquid foam composition. The foam dispenser further includes a foam dispensing pump having mesh within a liquid passage, a closure securing the foam dispensing pump assembly within the container, and a nozzle operably connected to the foam dispensing pump and extending from the closure. The nozzle is fluidly connected to the liquid passage.

### CROSS-REFERENCE TO RELATED APPLICATION

This application claims the benefit of priority of U.S. provisional application No. 62/355,402, filed Jun. 28, 2016, the contents of which are herein incorporated by reference.

### BACKGROUND OF THE INVENTION

The present invention relates to edible foam for beverages and, more particularly, to a foam formula and dispensing apparatus.

Sweet and edible foams are used to top hot drinks, such as hot chocolate and coffee. Current edible foams need to be refrigerated because they contain a fresh cream ingredient. Further, other edible foams may require the use of nitrous oxide pressure dispensers.

As can be seen, there is a need for a foam formula that has improved shelf life and a dispensing apparatus that does not require the use of a nitrous oxide.

### SUMMARY OF THE INVENTION

In one aspect of the present invention, a liquid foam composition comprises a combination of water, a whey protein isolate, and a quillaia extract.

In another aspect of the present invention, a foam dispenser comprises:

a container, wherein the liquid foam composition mentioned above is disposed within the container; a foam dispensing pump comprising mesh inserts within a liquid passage; a closure securing the foam dispensing pump within the container; and a nozzle operably connected to the foam dispensing pump and extending from the closure, wherein the nozzle is fluidly connected to the liquid passage.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention with an actuator in a locked position;

FIG. 2 is a perspective view of an embodiment of the present invention with an actuator in an unlocked position;

FIG. 3 is an exploded view of an embodiment of the present invention;

FIG. 4 is a section view of the present invention, taken along line 4-4 in FIG. 2;

FIG. 5 is a section view of an embodiment of the present invention illustrating the depression of an actuator; and

FIG. 6 is a flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a shelf stable latte foamer. The present invention may be used with coffee and hot chocolate. Where current foams will dissolve quickly in hot beverages, the present invention includes a formulation that allows the foam to be firm for an extended time period, about 2 hours, on hot beverages. The foam is also long lasting on alcoholic beverages, milks, carbonated products, juice beverages as well as use in desserts or breakfast products like pancakes.

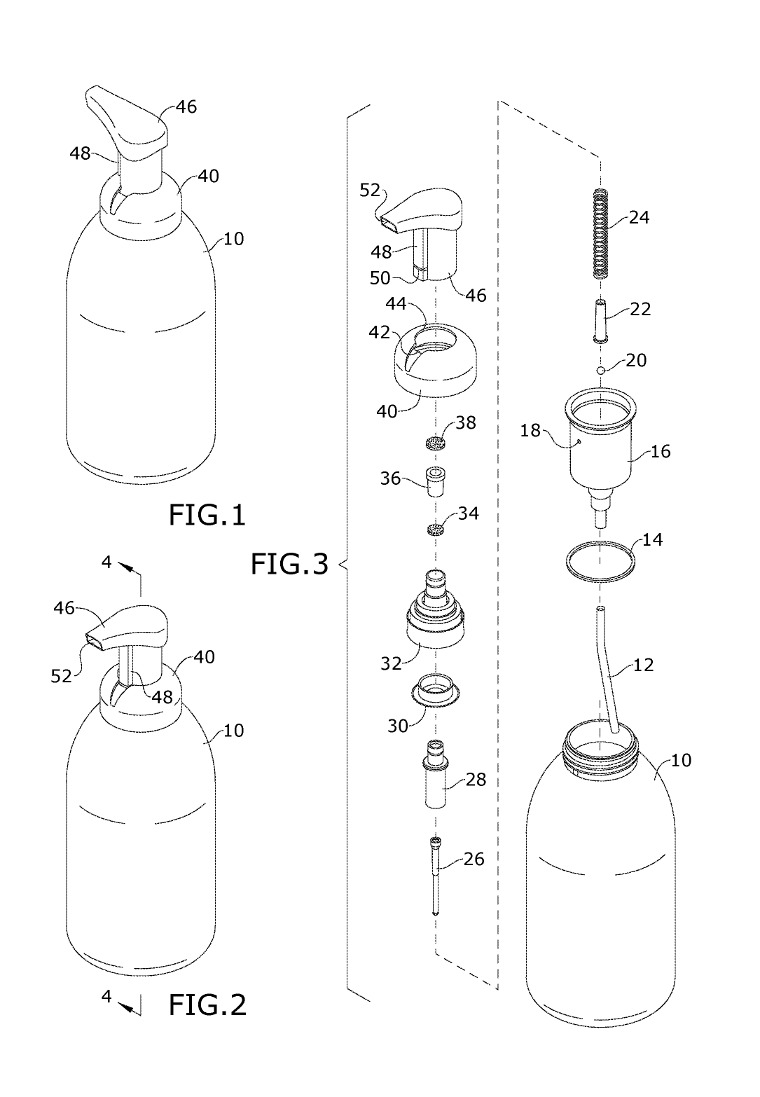

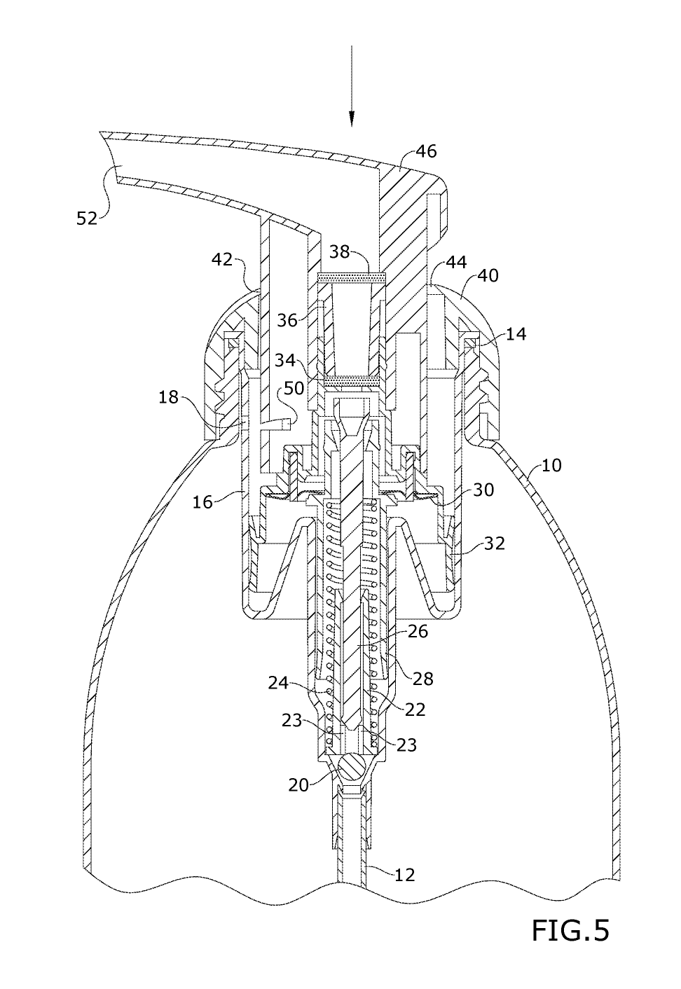

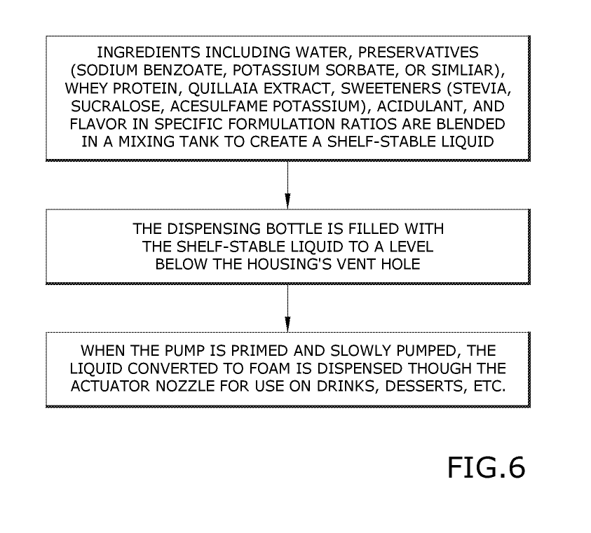

Referring to FIGS. 1 through 6, the present invention includes a foam dispenser. The foam dispenser includes a container 10 that contains the foamable liquid up to a liquid level 54. The container 10 may include external threads on an outer circumferential edge portion of its opening. A closure 40 has a large opening which is provided in its top wall and an outer circumferential portion which is threaded internally. The closure 40 is engaged threadably and sealingly with the container 10 to firmly fasten a foam dispensing pump to the container 10.

The foam dispensing pump includes a housing 16 formed of a double cylinder. The double cylinder includes a large air cylinder and a small liquid cylinder, which are formed concentrically with each other. An upper opening edge portion of the double cylinder has a fitting annular portion fitted in a locking arrangement between the container 10 and the closure 40.

The present invention may further include an air piston 32 and a liquid piston 28 assembled in a concentric arrangement to each other. When these pistons 32 and 28 are forced into the air cylinder and the liquid cylinder respectively at assembly, a coil spring 24 is inserted between the liquid cylinder and the liquid piston 28 so that the pistons 32, 28 are urged upwardly at all times by the spring 24.

The housing 16 includes a cylindrical wall portion disposed below the fitting annular portion and a bottom wall portion extending diametrically inwardly from a lower end of the cylindrical wall and then turning upwardly at its central portion. The liquid cylinder includes a cylindrical wall portion extending downwardly in continuation from an upper end of the turned up portion of the bottom wall portion of the air cylinder. An annular seat is formed on an inner surface to provide a seat for receiving a lower end of a spring stem 22. A funnel-shaped valve seat portion is formed below the annular seat for providing a valve seat for a ball valve 20 and a cylindrical lower hole portion terminating the liquid cylinder.

The cylindrical wall portion of the housing 16 has, at its upper end portion, an air hole 18 for introducing air into the container 10.

The ball valve 20 constitutes a first check valve for opening an inlet of a liquid chamber, which is defined by the liquid cylinder of the housing 16 and the liquid piston 28, when a negative pressure prevails in the liquid chamber.

Press-fitted to the lower hole portion of the liquid cylinder of the housing 16, there is a dip tube 12 which extends to reach the bottom of the container 10.

Thus, the air piston 32 and the liquid piston 28, serving as the piston of the foam dispensing pump of the present invention, moves up and down in the air cylinder and the liquid cylinder of the housing 16.

The air piston 32 includes a cap-shaped air chamber portion, an annular sliding seal portion extending downwardly and outwardly from the lower end of the air chamber portion and moving up and down sealingly in sliding contact with inner surfaces of the cylindrical wall of the housing 16 to create sufficient hermetic seal. A hollow rod portion extends upwardly from a central portion of the air chamber portion and an annular seal portion extends upwardly and outwardly from an upper portion of the air chamber portion.

The hollow rod portion of the air piston 32 includes a lower portion, in which the liquid piston 28 fits within and an upper portion forming a mixing chamber. A gasket 30 fits in between the air piston 32 and the liquid piston 28. An internal diameter of the lower portion is substantially equal to an external diameter of the liquid piston 28, and the lower portion has a plurality of relatively wide vertical grooves for forming an air passage in conjunction with the outer surface of the liquid piston 28. The upper portion of the hollow rod portion has seat disposed within and an opening formed therethrough leading into the mixing chamber.

The liquid piston 28 is provided, on an inner surface of its upper end portion, with a valve seat, which is funnel-shaped to have a larger internal diameter towards its upper end portion, and, at its lower end portion, with a sliding seal portion which moves up and down sealingly in the cylindrical wall portion of the liquid cylinder.

In the liquid piston 28, as shown, there is fitted a rod valve member 26. The rod valve member 26 forms a second check valve. This second check valve opens and closes a liquid outlet at an upper end of the liquid piston 28 as the housing 16 and the liquid piston 28 is moved up and down. The rod valve member 26 is formed to have a larger rod portion at its upper portion and a smaller rod portion at its lower portion. At the upper end of the larger rod portion of the rod valve member 26 is a valve head portion of an inverted conical shape. At a lower end of the smaller rod portion of the rod valve member 26 is a diametrically enlarged portion extending from the smaller rod portion via a step and then converging towards its bottom end. The larger rod portion of the rod valve-member 26 has an external diameter smaller than the internal diameter of the smaller diameter portion of the liquid piston 28 so that a liquid passage is formed when the larger rod portion is inserted into the upper portion of the liquid piston 26. Further, at least the largest diameter of the cone of the valve head portion at the upper end of the rod valve member is larger than the smallest diameter of the funnel-shaped valve seat at the upper end portion of the liquid piston 26, so that valve actions for opening or closing the liquid outlet at the upper-end of the liquid piston 26 are effected by the valve portion in conjunction with the funnel-shaped valve seat at the upper end of the liquid piston 26.

As mentioned above, the spring stem 22 sits against the annular se at formed on the inner surface of the housing 16. The diametrically enlarged portion of the rod valve member 26 is disposed within the spring stem 22. The spring stem 22 includes an upper opening comprising a smaller diameter than the diametrically enlarged portion, preventing the enlarged portion from passing through. Further, a stopper 23 is disposed at a bottom end of the spring stem 22, preventing the enlarged portion to pass through the spring stem 22 at the bottom end. The present invention further includes an actuator 46. A nozzle member 52 of the actuator 46 has an L-shaped foam passage. The actuator 46 further includes an inner and outer cylindrical walls. The outer cylindrical wall fits through a closure lip 44 of the closure 40. The outer cylindrical wall further includes a vertically disposed ridge 48 and a slot 50 formed through the ridge 48 and forming an air passage into an air chamber formed in between the inner and outer cylindrical walls. The ridge 48 may slide along a closure slot 42 formed in the closure lip 44. To lock the actuator 46, the actuator 46 may be rotated about a vertical axis so that the closure lip 44 is disposed within the slot 50. To unlock the actuator 46, the actuator 46 is rotated back about the vertical axis so that the closure lip 44 is outside the slot 50 and the ridge 48 is aligned with the closure slot 42.

The present invention may further include a first mesh layer 34 and a second mesh layer 38 separate by a mesh insert 36. The mesh insert 36 includes a cylinder having an upper opening and a lower opening. The first mesh layer 34 and the bottom portion of the mesh insert 36 fits within the mixing chamber of the air piston 32 and the second mesh layer 38 and a top portion of the mesh insert 36 fit within the inner cylindrical wall of the actuator 46. The inner cylindrical wall of the actuator 46 further fits over an outer surface of the upper portion of the air piston 32, connecting the actuator 46 to the air piston 32.

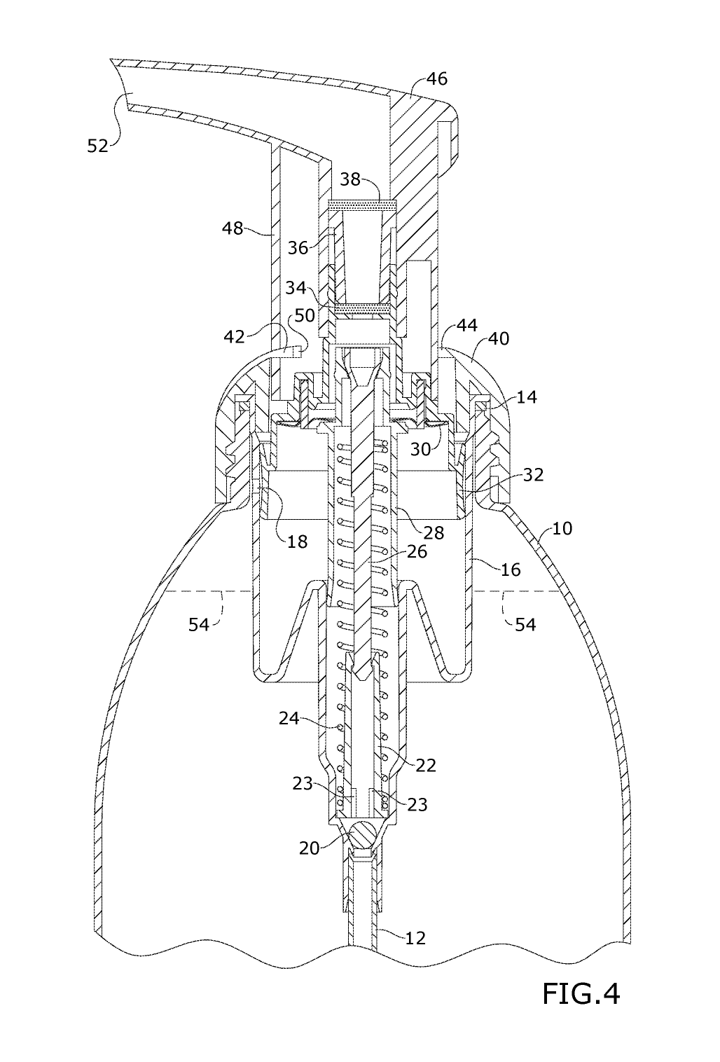

To operate this foam dispensing pump container, the actuator 40 is rotated about a vertical axis so that the ridge 48 aligns with the slot 42. In this configuration, the actuator 40 may be pushed downwards. When the actuator 40 is depressed by one's hand against repelling force of the coil spring 24, the air piston 32, and the liquid piston 28 move down simultaneously. At this time, the ball 20 of the first check valve is urged away from the valve seat portion by pressure of the foamable liquid in the container 10, priming the foam dispenser. The rod valve member 26 does not move relative to the liquid piston 28 until the enlarged portion comes into abutment against the stopper 23 and is forced upward so that the valve member portion of the rod valve member 26 of the second check valve seated in the funnel-shaped valve seat to close the liquid outlet at the upper end of the liquid piston 28 in FIG. 4 breaks contact with the valve seat and the outlet of the liquid passage to the mixing chamber 26 is opened. The foamable liquid is pumped through the liquid passage into the mixing chamber 26 and converted to foam by the upper and lower mesh 34, 38. The foam then travels out of the nozzle 56 and into a drink.

The present invention further includes the foamable liquid. The foamable liquid includes water mixed with a surfactant and an emulsifier. The emulsifier is used for the creation and formation of the initial foam bubbles. The surfactant stabilizes the bubbles of the foam and thereby produces a long-lasting foam. The emulsifier ingredient is protected by the surfactant to hold the foam bubbles in place after dispensed through the pump.

The foamable liquid may further include preservatives, sweeteners, acidulants, rosemary extract, an antioxidant, an antimicrobial solution and the like. The preservatives may include, but are not limited to, benzoate, potassium sorbate, or other natural preservatives. The sweeteners may include, but are not limited to, stevia, sugar, sucralose, sugar alcohols, monk fruit, psicose, acesulfame potassium, aspartame, and the like.

Surfactants are compounds that lower the surface tension between two liquids. The surfactant of the present invention may include, but is not limited to, methylcellulose, cellulose ethers, whey protein isolate or a combination thereof.

An emulsifier is a substance that stabilizes an emulsion by increasing its kinetic stability. The emulsifier of the present invention may include, but is not limited to, quillaia extract, yucca extract, cactus extract, a synthetic emulsifier or a combination thereof.

A proportion of each ingredient of the foamable liquid may include the following: the surfactant ranging from about 0.05% up to about 0.5%, such as about 0.10% up to about 0.20%, of the foamable liquid; the emulsifier ranging from about 0.05% up to about 0.5%, such as about 0.10% up to about 0.20%, of the foamable liquid; and sweeteners ranging from about 0.01% up to about 20% of the foamable liquid. The water may be about 65% up to about 99.8% of the foamable liquid.

The foamable liquid may include an acidic pH. The acidic pH ranges between about 1.5 pH up to about 6 pH, about 2 pH up to about 5 pH, about 3.0 pH up to about 4.5 pH, such as about 4 pH. The acidic pH range increases the control of the foam production. A shelf life of the foamable liquid is increased by the preservatives up to about 36 months. Color, low proof alcohol and other flavors can be added to the foamable liquid to modify or change the end use application.

A method of making the formulation may include the following. Blend the ingredients, including water, preservatives, whey protein, quillaia extract, sweeteners, Acesulfame Potassium and Acidulant flavor, in a mixing tank. The above listed ingredients are blended in the proportions listed above. The order of mixing the ingredients may include the following: water, preservatives, whey protein, sweeteners, flavoring and then quillaia.

It should be understood, of course, that the foregoing relates to exemplary embodiments of the invention and that modifications may be made without departing from the spirit and scope of the invention as set forth in the following claims.

What is claimed is:

1. A liquid foam composition comprising a combination of water, a surfactant, and an emulsifier.

2. The liquid foam composition of claim 1, wherein the surfactant is methylcellulose, cellulose ethers, whey protein isolate or a combination thereof.

3. The liquid foam composition of claim 1, wherein the emulsifier is quillaia extract, yucca extract, cactus extract, a synthetic emulsifier or a combination thereof.

4. The liquid foam composition of claim 1, comprising an acidic pH.

5. The liquid foam composition of claim 4, wherein the acidic pH ranges from about 1.5 up to about 6.

6. The liquid foam composition of claim 5, wherein the acidic pH ranges from about 3 up to about 4.

7. The liquid foam composition of claim 1, wherein the surfactant ranges between about 0.05% up to about 0.5% of the combination.

8. The liquid foam composition of claim 1, wherein the emulsifier ranges between about 0.05% up to about 0.5% of the combination.

9. The liquid foam composition of claim 1, wherein the combination further comprises a sweetener.

10. The liquid foam composition of claim 9, wherein the sweetener is stevia, sugar, sucralose, alcohol sugars, monk fruit, psicose, acesulfame potassium, aspartame, or a combination thereof.

11. The liquid foam composition of claim 1, wherein the combination further comprises a preservative.

12. The liquid foam composition of claim 11, wherein the preservative is benzoate, potassium sorbate, or a combination thereof.

13. The liquid foam composition of claim 1, wherein the combination further comprises acidulants.

14. The liquid foam composition of claim 1, wherein the composition further comprises rosemary extract, an antioxidant, an antimicrobial solution, or a combination thereof.

15. A foam dispenser comprising:
a container, wherein the liquid foam composition of claim 1 is disposed within the container;
a foam dispensing pump comprising mesh within a liquid passage;
a closure securing the foam dispensing pump assembly within the container; and
a nozzle operably connected to the foam dispensing pump and extending from the closure, wherein the nozzle is fluidly connected to the liquid passage.
